(19) United States
(12) Patent Application Publication
(10) Pub. No.: US 2024/0184647 A1
(43) Pub. Date: Jun. 6, 2024

(54) PROGRAM CONTROL DEVICE, PROGRAM CONTROL METHOD, AND PROGRAM CONTROL PROGRAM

(71) Applicant: NEC Corporation, Tokyo (JP)

(72) Inventor: Yoshiyuki OHNO, Tokyo (JP)

(73) Assignee: NEC Corporation, Tokyo (JP)

(21) Appl. No.: 18/522,312

(22) Filed: Nov. 29, 2023

(30) Foreign Application Priority Data
Dec. 2, 2022 (JP) 2022-193356

(51) Int. Cl. G06F 9/54

(52) U.S. Cl. CPC G06F 9/544

(57) ABSTRACT

A program control device includes a conversion unit which converts multiple programs to be simultaneously executed by an accelerator into intermediate representations indicating computation operations to be executed by programs and memory information indicating an amount of memory required by data used in the computation operations, respectively, and a determination unit which determines an execution order of multiple intermediate representations so that an amount of memory usage used by the accelerator when the accelerator executes the multiple programs simultaneously is below a threshold value of the memory based on the converted multiple intermediate representations and multiple memory information.

This application is based upon and claims the benefit of priority from Japanese patent application No.2022-193356, filed on Dec. 2, 2022, the disclosure of which is incorporated here in its entirety by reference.

### BACKGROUND

### Technical Field

The present invention relates to a program control device, a program control method, and a program control program, and in particular to a program control device, a program control method, and a program control program that enable simultaneous execution of multiple programs by a GPU (Graphics Processing Unit).

### Related Art

In the development of AI (Artificial Intelligence), accelerators such as GPUs are mainly used as computing devices. Among accelerators, GPUs are expected to be used in more and more technological fields.

High costs are required to purchase and operate individual GPUs, which are expensive and have high power consumption. Therefore, instead of purchasing and operating individual GPUs, the roles of multiple GPUs could be consolidated into a single GPU. For the above reasons, it is expected that “consolidation” of GPUs will take place in the development of AI.

When consolidating servers with GPUs, virtualization and sharing technologies for GPUs are important. For example, a single GPU is required to execute multiple programs.

FIG. 26 is an explanatory diagram showing an example of multiple program execution entities. For example, the areas with diagonal lines from the upper left of Program A shown in FIG. 26 are the areas where the GPU is performing the computations for Program A. The white areas of Program A shown in FIG. 26 are the areas where the CPU (Central Processing Unit) is performing the computations for Program A instead of the GPU.

The areas with diagonal lines from the upper right of Program B shown in FIG. 26 are the areas where the GPU is performing the computations for Program B. The white areas of Program B shown in FIG. 26 are the areas where the CPU is performing the computations for Program B instead of the GPU.

When the execution of Programs A to B shown in FIG. 26 is consolidated into a single GPU, the use efficiency of GPU increases if the GPU is used in a time-shared manner. In other words, as shown in the lower of FIG. 26, staggering the time when the single GPU executes Programs A to B increases the use efficiency of GPU.

However, the method of using the GPU in a time-shared manner has the problem that the program will not run if the GPU runs out of memory. FIG. 27 is an explanatory diagram showing another example of multiple program execution entities.

If the GPU is used to execute Programs A to B at the same timing, as represented by the two dashed rounded corner rectangles shown in FIG. 27, either or both programs will stop with an error if the GPU does not have enough memory. In the example shown in FIG. 27, either or both of the computation in the area with diagonal lines from the upper left and the computation in the area with diagonal lines from the upper right shown in the center of FIG. 27 will stop.

Unified Memory is a technology that solves the above problem by allowing the CPU memory and GPU memory to be treated as a single memory: An original object of setting up Unified Memory is to omit explicit programming a data communication between the CPU and the GPU. When Unified Memory is used, the GPU can virtually handle large amounts of memory.

FIG. 28 is a block diagram showing an example of the configuration of a computing device in which Unified Memory is not used. The computing device shown in FIG. 28 has a CPU, a CPU memory, a GPU, and a GPU memory. If the GPU shown in FIG. 28 tries to allocate memory larger than the GPU memory, an error occurs.

FIG. 29 is a block diagram showing an example of the configuration of a computing device in which Unified Memory is used. Unlike the computing device shown in FIG. 28, the computing device shown in FIG. 29 uses Unified Memory.

When Unified Memory is used, data in GPU memory is automatically moved to CPU memory when the CPU tries to access data in Unified Memory. Also, when the GPU tries to access the data in Unified Memory, the data in CPU memory is automatically moved to GPU memory.

In other words, when Unified Memory is used, the GPU can handle memory that is virtually larger than the GPU memory in size. Therefore, one technique to solve the issue illustrated in FIG. 27 is to use Unified Memory.

In addition, Japanese Patent Application Laid-Open No. 2022-022642 describes an information processing device that makes it possible to achieve effective use of memory resources.

In addition, Japanese Patent Application Laid-Open No. 2014-229173 describes an accelerator processing execution device that can improve the program productivity of programmers who develop applications that use accelerators.

In addition, Japanese Patent Application Laid-Open No. 2008-165746 describes an accelerator that has multiple computing units and can execute a program by parallel processing to determine the division of labor among the multiple computing units within itself.

### SUMMARY

Therefore, it is an object of the present invention to provide a program control device, a program control method, and a program control program that enable an accelerator to simultaneously execute multiple programs at high speed without running out of memory in the accelerator.

A program control device according to the present invention is a program control device includes a conversion unit which converts multiple programs to be simultaneously executed by an accelerator into intermediate representations indicating computation operations to be executed by programs and memory information indicating an amount of memory required by data used in the computation operations, respectively, and a determination unit which determines an execution order of multiple intermediate representations so that an amount of memory usage used by the accelerator when the accelerator executes the multiple programs simultaneously is below a threshold value of the memory based on the converted multiple intermediate representations and multiple memory information.

A program control method according to the present invention is a program control method includes converting multiple programs to be simultaneously executed by an accelerator into intermediate representations indicating computation operations to be executed by programs and memory information indicating an amount of memory required by data used in the computation operations, respectively, and determining an execution order of multiple intermediate representations so that an amount of memory usage used by the accelerator when the accelerator executes the multiple programs simultaneously is below a threshold value of the memory based on the converted multiple intermediate representations and multiple memory information.

A program control program according to the present invention, causing an accelerator to execute a conversion process of converting multiple programs to be simultaneously executed by the accelerator into intermediate representations indicating computation operations to be executed by programs and memory information indicating an amount of memory required by data used in the computation operations, respectively, and a determination process of determining an execution order of multiple intermediate representations so that an amount of memory usage used by the accelerator when the accelerator executes the multiple programs simultaneously is below a threshold value of the memory based on the converted multiple intermediate representations and multiple memory information.

### BRIEF DESCRIPTION OF DRAWINGS

FIG. 1 is a block diagram showing an example of the configuration of a program control device of the example embodiment of the present invention;

FIG. 2 is an explanatory diagram showing an example of a program control processing by the program control device 100 of this example embodiment;

FIG. 3 is an explanatory diagram showing an example of a user program input to the IR generation unit 110;

FIG. 4 is an explanatory diagram showing an example of a library program input to the IR generation unit 110;

FIG. 5 is an explanatory diagram showing an example of used memory information that is referenced by the IR generation unit 110;

FIG. 6 is an explanatory diagram showing an example of IR with the used memory amount information that is generated by the IR generation unit 110;

FIG. 7 is an explanatory diagram showing an example of an amount of memory usage estimated by the IR execution order determination unit 130 based on the IR with the used memory amount information;

FIG. 8 is an explanatory diagram showing an example of GPU memory when the IR execution unit 140 executes an IR;

FIG. 9 is an explanatory diagram showing another example of GPU memory when the IR execution unit 140 executes an IR;

FIG. 10 is an explanatory diagram showing another example of GPU memory when the IR execution unit 140 executes an IR:

FIG. 11 is an explanatory diagram showing an example of the IR with the used memory amount information that is generated by an IR generation unit 120;

FIG. 12 is an explanatory diagram showing another example of an amount of memory usage estimated by the IR execution order determination unit 130 based on the IR with the used memory amount information;

FIG. 13 is an explanatory diagram showing another example of an amount of memory usage estimated by the IR execution order determination unit 130 based on the IR with the used memory amount information;

FIG. 14 is an explanatory diagram showing another example of an amount of memory usage estimated by the IR execution order determination unit 130 based on the IR with the used memory amount information;

FIG. 15 is an explanatory diagram showing another example of an amount of memory usage estimated by the IR execution order determination unit 130 based on the IR with the used memory amount information;

FIG. 16 is an explanatory diagram showing another example of an amount of memory usage estimated by the IR execution order determination unit 130 based on the IR with the used memory amount information;

FIG. 17 is an explanatory diagram showing another example of GPU memory when the IR execution unit 140 executes an IR;

FIG. 18 is a flowchart showing an operation of the IR execution process by the program control device 100 of the present example embodiment;

FIG. 19 is an explanatory diagram showing another example of the IR with the used memory amount information that is generated by the IR generation unit 120;

FIG. 20 is an explanatory diagram showing another example of an amount of memory usage estimated by the IR execution order determination unit 130 based on the IR with the used memory amount information;

FIG. 21 is an explanatory diagram showing another example of an amount of memory usage estimated by the IR execution order determination unit 130 based on the IR with the used memory amount information;

FIG. 22 is an explanatory diagram showing another example of an amount of memory usage estimated by the IR execution order determination unit 130 based on the IR with the used memory amount information;

FIG. 23 is an explanatory diagram showing another example of an amount of memory usage estimated by the IR execution order determination unit 130 based on the IR with the used memory amount information;

FIG. 24 is an explanatory diagram showing an example of a hardware configuration of the program control device 100 according to the present invention;

FIG. 25 is a block diagram showing an overview of a program control device according to the present invention;

FIG. 26 is an explanatory diagram showing an example of multiple program execution entities;

FIG. 27 is an explanatory diagram showing another example of multiple program execution entities;

FIG. 28 is a block diagram showing an example of the configuration of a computing device in which Unified Memory is not used; and

FIG. 29 is a block diagram showing an example of the configuration of a computing device in which Unified Memory is used.

### DETAILED DESCRIPTION

### Description of Configuration

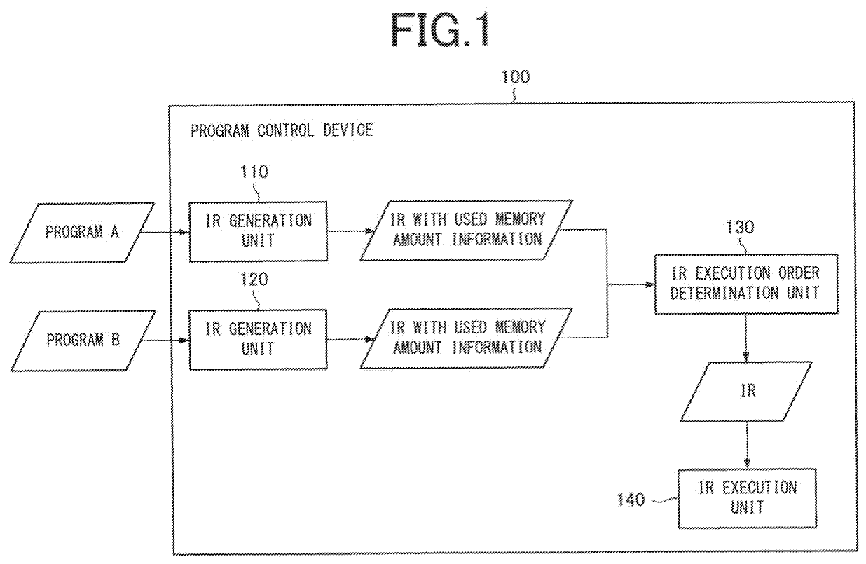

Hereinafter, an example embodiment of the present invention will be described with reference to the drawings. FIG. 1 is a block diagram showing an example of the configuration of a program control device of the example embodiment of the present invention.

The program control device 100 of this example embodiment is characterized by converting the program into an Intermediate Representation (IR) in which the used memory amount information is retained, and controlling the execution order of the IR based on the used memory amount information.

Common forms of program execution include a form of compiling a program to generate object code and executing the generated object code, or a form of executing instructions one by one in an interpreter method.

Common forms of program execution also include a form of converting instructions into IRs one by one using the interpreter method, and executing the converted IRs. The program control device 100 of this example embodiment utilizes the method of converting a program into IRs and executing the converted IRs.

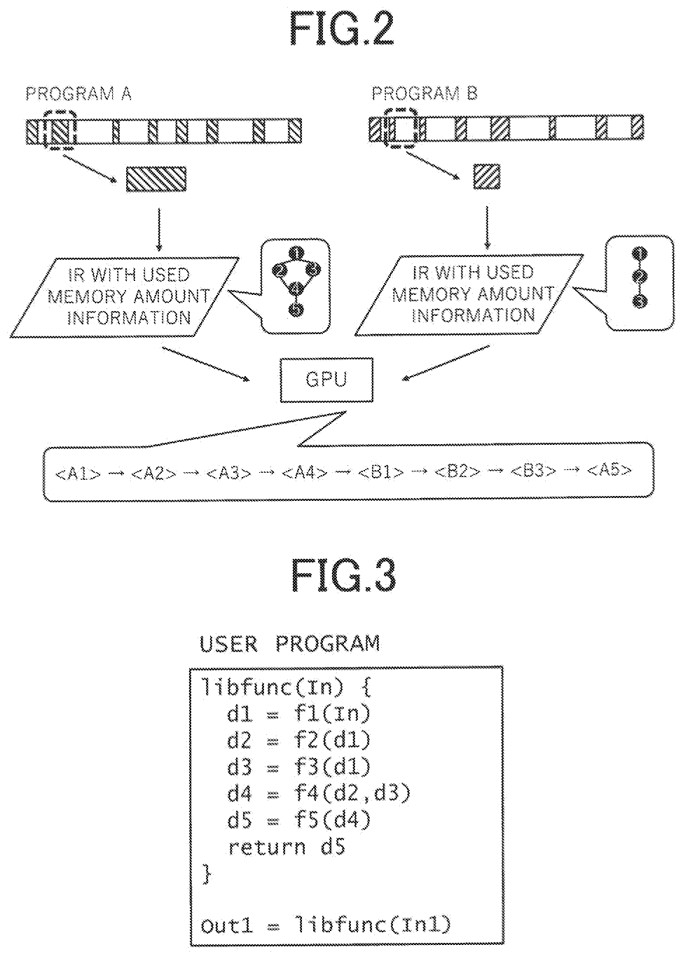

FIG. 2 is an explanatory diagram showing an example of a program control processing by the program control device 100 of this example embodiment. In the example shown in FIG. 2, the program control device 100 converts the portion of Program A that performs computations in the area with diagonal lines from the upper left and the portion of Program B that performs computations in the area with diagonal lines from the upper right shown in the center of FIG. 27 into IR with the used memory amount information, respectively.

The graphs shown in the callouts to the right of each IR with the used memory amount information are computation graphs that represent the order of processing of computations performed in each area. The information of the computation graph is included in the IR with the used memory amount information.

For example, the computation graph corresponding to the area with diagonal lines from the upper left shown in FIG. 2 represents that Process 1 is executed first, Process 2 and Process 3 are executed based on the results of Process 1, Process 4 is executed based on the results of each of Process 2 and Process 3, and Process 5 is executed based on the results of Process 4.

As shown in FIG. 2, the GPU accepts the IR with the used memory amount information to which multiple user programs have been converted. The GPU then controls the execution order of each IR so that the GPU memory does not run out.

In the example shown in FIG. 2, the GPU decides to execute each process in the order <A1>-><A2>-><A3>-><A4>-><B1>-><B2>-><B3>-><A5> based on each the IR with the used memory amount information. For example, <A1> represents Process 1 of Program A, and <B1> represents Process 1 of Program B.

The program control device 100 shown in FIG. 1 includes an IR generation unit 110, an IR generation unit 120, an IR execution order determination unit 130, and an IR execution unit 140.

The IR generation unit 110 has the function of generating the IR with the used memory amount information from the input Program A. The IR generation unit 120 has the function of generating the IR with the used memory amount information from the input Program B.

The Programs A to B of this example embodiment are the programs input by users A to B, respectively. The program control device 100 may have three or more IR generation units.

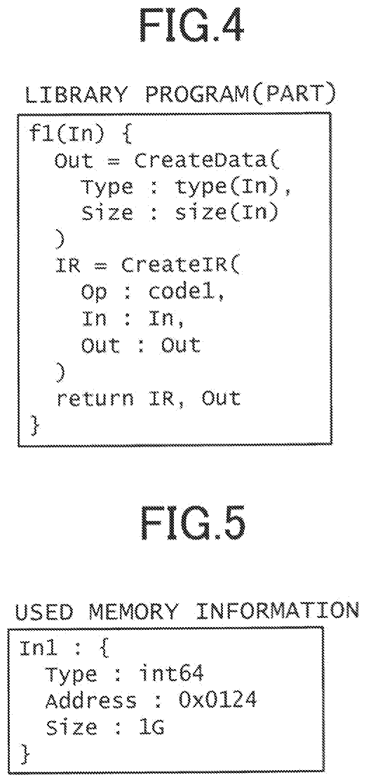

The IR generation unit 110 and IR generation unit 120 are given programs as input. The programs given are divided into user programs and library programs. FIG. 3 is an explanatory diagram showing an example of a user program input to the IR generation unit 110. FIG. 4 is an explanatory diagram showing an example of a library program input to the IR generation unit 110.

When generating the IR with the used memory amount information, the IR generation unit 110 and IR generation unit 120 refer to the used memory information that is retained internally. FIG. 5 is an explanatory diagram showing an example of used memory information that is referenced by the IR generation unit 110.

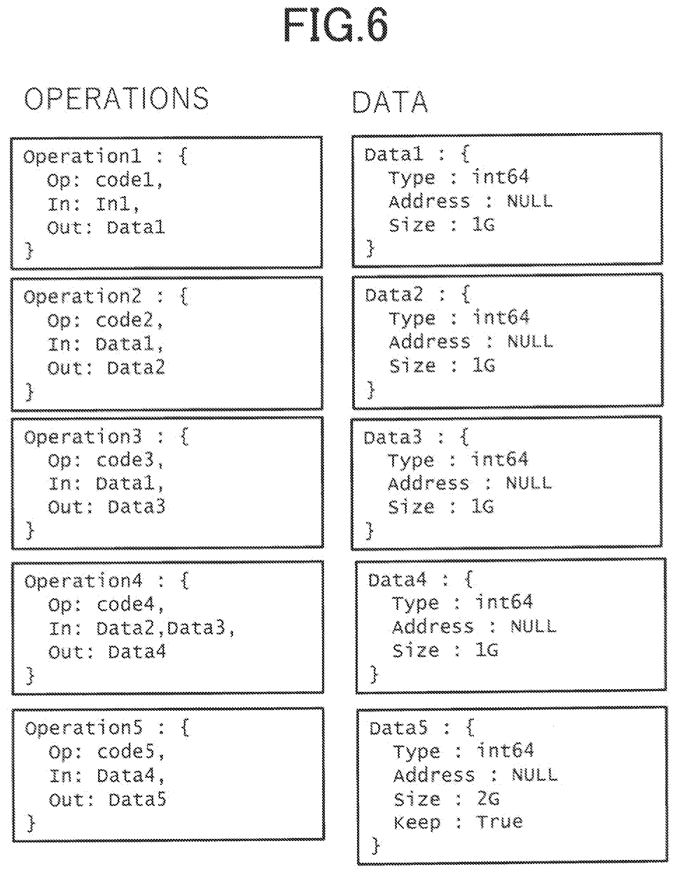

The IR generation unit 110 and IR generation unit 120 generate the IR with the used memory amount information without executing the program based on the user program, library program, and used memory information. FIG. 6 is an explanatory diagram showing an example of IR with the used memory amount information that is generated by the IR generation unit 110.

As shown in FIG. 6, the IR with the used memory amount information of this example embodiment consists of Operation information (IR), which indicates the contents of the computation, and Data information, which indicates the used memory amount. The IR with the used memory amount information shown in FIG. 6 is the IR with the used memory amount information converted from the portion of Program A that performs computations in the area with diagonal lines from the upper left shown in FIG. 2.

For example, based on the user program shown in FIG. 3 and the library program shown in FIG. 4, the IR generation unit 110 generates the Operation information “Operation1”, which indicates Process 1 executed first. Also, based on the user program shown in FIG. 3 and the used memory information shown in FIG. 5, the IR generation unit 110 generates the Data information “Data1”, which indicates the amount of memory used in Process 1 executed first.

The Data information “Data5” shown in FIG. 6 includes “Keep,” which is life/death information of variables in the program. The reason for this is that the first level data (“Out1”) in the user program is required to be maintained even after the IR is executed. In addition, the data in the function (“Data1” to “Data4”) is not needed after the IR is executed, so a Keep Flag is not assigned to the Data information “Data1” to “Data4”.

The IR generation unit 110 and IR generation unit 120 input the generated IR with the used memory amount information to the IR execution order determination unit 130. The IR execution order determination unit 130 estimates the amount of memory usage based on the input IR with the used memory amount information.

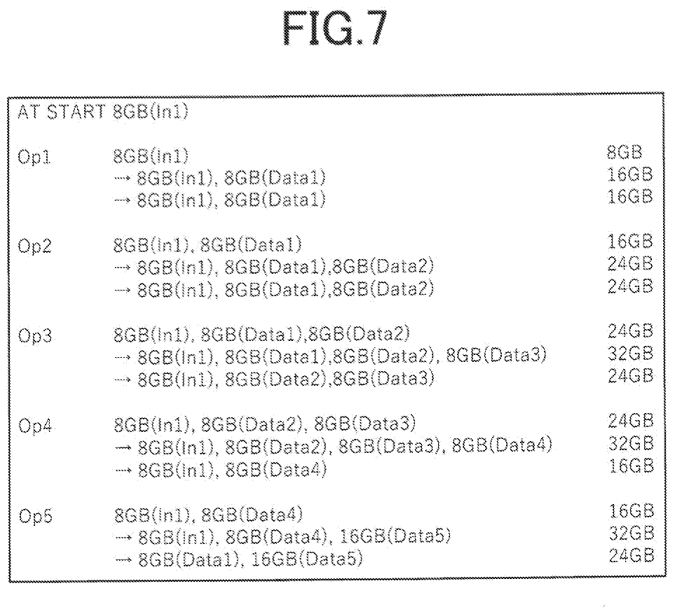

FIG. 7 is an explanatory diagram showing an example of an amount of memory usage estimated by the IR execution order determination unit 130 based on the IR with the used memory amount information. FIG. 7 shows the amount of memory usage that the IR execution order determination unit 130 estimates based on the IR with the used memory amount information shown in FIG. 6, which is input from the IR generation unit 110.

As shown in FIG. 7, based on the Operation information “Operation1” and the Data information “Data1”, the IR execution order determination unit 130 analyzes that in Process 1 of the computation (“Op1” shown in FIG. 7), input data “In1” with a size of 8 GB and output data “Data1” with a size of 8 GB are used.

The Data information “Data1” indicates that “Data1” is a 64-bit signed integer with a size of 1 G. Therefore, the IR execution order determination unit 130 estimates that the amount of memory usage of the output data “Data1” is 8 Bytes×1G=8 GB.

Therefore, the IR execution order determination unit 130 estimates that the maximum amount of memory usage in Process 1 of the computation is 16 GB. Each line in “Op1” shown in FIG. 7 represents the input data and the amount of memory usage in Process 1 of the computation, data and the amount of memory usage during the execution of the process, and output data and the amount of memory usage (the same applies to “Op2” through “Op5” shown in FIG. 7), respectively. The value shown on the right side of FIG. 7 is the total amount of memory usage for each data.

Similarly, the IR execution order determination unit 130 estimates the maximum amount of each memory usage in Processes 2 to 5 (“Op2” to “Op5” shown in FIG. 7) of the computation to be 24 GB, 32 GB, 32 GB and 32 GB, respectively.

In the example shown in FIG. 7, the output data “In1” is data to which the Keep Flag has been assigned in advance, so it remains unused in “Op2” to “Op5” after “Op1”. In addition, the output data “Data1” in “Op1” shown in FIG. 7 is the input data for “Op2” and “Op3” after “Op1,” so it remains at the end of “Op1” shown in FIG. 7.

The output data “Data1” in “Op2” shown in FIG. 7 is the input data for “Op3” after “Op2”, and the output data “Data2” is the input data for “Op4” after “Op2”, so both of them remain at the end of “Op2” shown in FIG. 7.

The output data “Data1” in “Op3” shown in FIG. 7 is deleted at the end of “Op3” shown in FIG. 7 because it is not used in “Op4” and “Op5” after “Op3”. Since the output data “Data2” and “Data3” in “Op3” shown in FIG. 7 are the input data for “Op4” after “Op3”, both of them remain at the end of “Op3” shown in FIG. 7.

For the same reason, in “Op4” shown in FIG. 7, the output data “Data2” and “Data3” that are determined to be unnecessary are deleted at the end of “Op4” shown in FIG. 7.

After estimating the amount of memory usage, the IR execution order determination unit 130 inputs the IRs to the IR execution unit 140. The IR execution unit 140 has the function of executing each program by executing the input IRs.

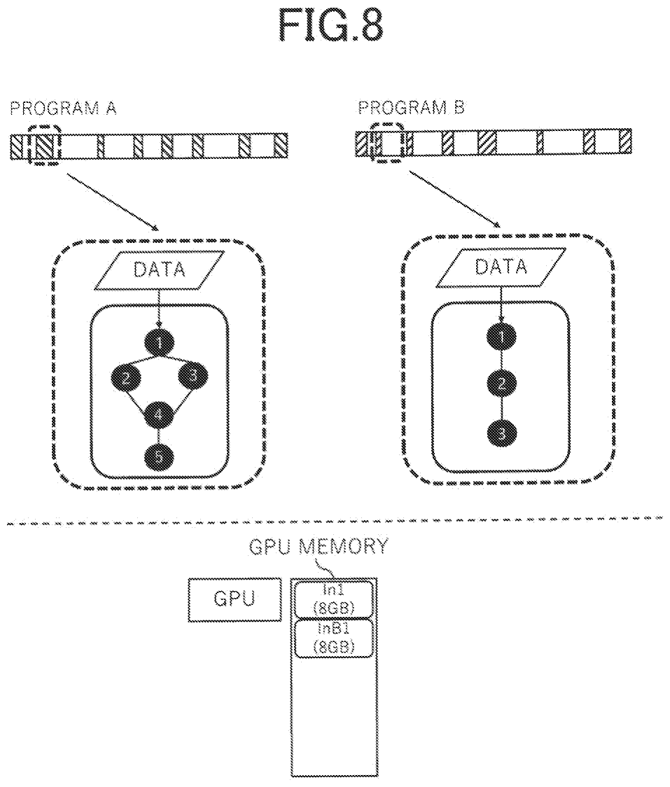

FIG. 8 is an explanatory diagram showing an example of GPU memory when the IR execution unit 140 executes an IR. The GPU shown in FIG. 8 corresponds to the IR execution unit 140. The GPU memory shown in FIG. 8 corresponds to the memory of the IR execution unit 140.

In the example shown in FIG. 8, the IR execution unit 140 executes the portion of Program A that performs computations in the area with diagonal lines from the upper left within the dashed rounded corner rectangle shown in FIG. 2 and the portion of Program B that performs computations in the area with diagonal lines from the upper right within the dashed rounded corner rectangle. As shown in the upper of FIG. 8, data is input to Program A and Program B from external sources in executing them.

Therefore, as shown in the lower of FIG. 8, input data “In1” and “InB1” are stored in the GPU memory at the start of each program execution. As shown in the lower of FIG. 8, the amount of memory usage for each of the input data “In1” and “InB1” is 8 GB each.

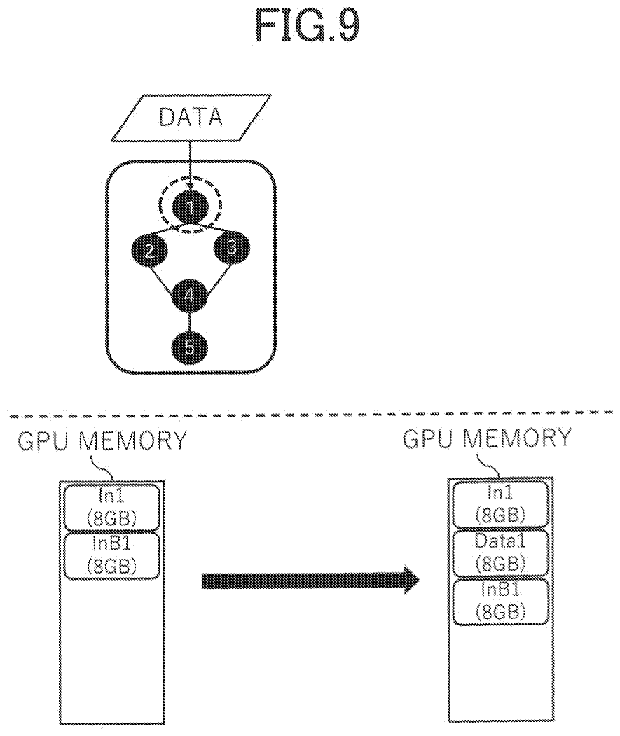

FIG. 9 is an explanatory diagram showing another example of GPU memory when the IR execution unit 140 executes an IR. The upper of FIG. 9 shows that Process 1 is computed in the execution of Program A. The result of the computation of Process 1 in Program A is stored in the GPU memory (the same applies to Program B).

Therefore, as shown in the lower of FIG. 9, output data “Data1” is newly stored in the right GPU memory. As shown in the lower of FIG. 9, the amount of memory usage of the output data “Data1” is 8 GB, as estimated in FIG. 7.

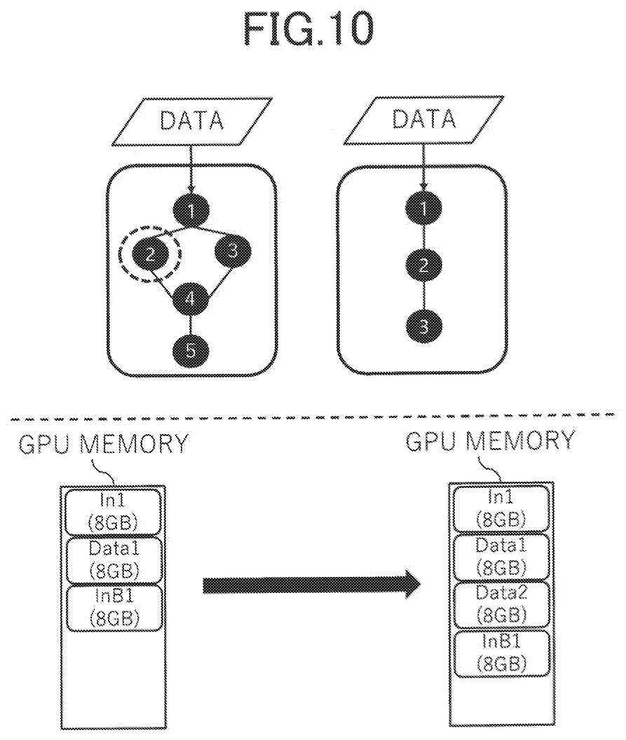

FIG. 10 is an explanatory diagram showing another example of GPU memory when the IR execution unit 140 executes an IR. The upper of FIG. 10 shows that Process 2 is being computed in the execution of Program A. The upper of FIG. 10 also shows that the execution of user B's program was requested during the execution of user A's program (in the middle of the computation of Process 2).

Therefore, as shown in the lower of FIG. 10, the output data “Data2” is newly stored in the right GPU memory. As shown in the lower of FIG. 10, the amount of memory usage of the output data “Data2” is 8 GB, as estimated in FIG. 7.

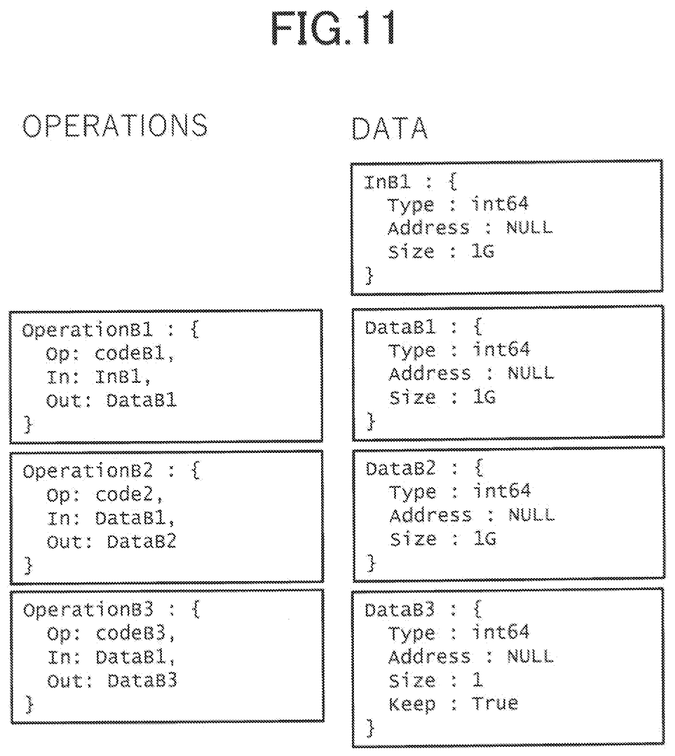

Upon receiving a request to execute Program B, the IR generation unit 120 generates IR with the used memory amount information. FIG. 11 is an explanatory diagram showing an example of the IR with the used memory amount information that is generated by an IR generation unit 120.

The IR with the used memory amount information shown in FIG. 11 is the IR with the used memory amount information converted from the portion of Program B that performs computations in the area with diagonal lines from the upper right within the dashed rounded corner rectangle shown in FIG. 8. The view of the IR with the used memory amount information shown in FIG. 11 is the same as that of the IR with the used memory amount information shown in FIG. 6.

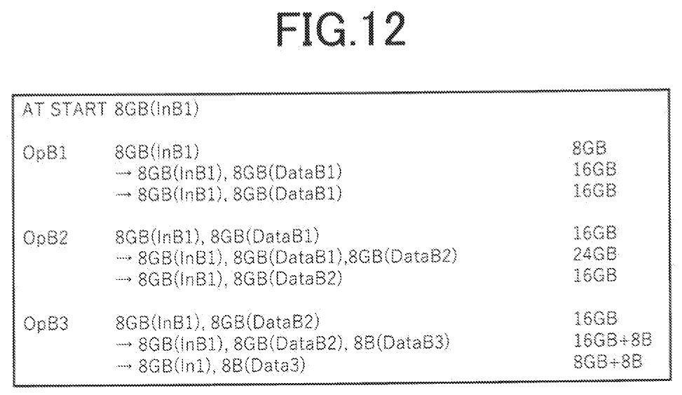

Upon generation of the IR with the used memory amount information, the IR execution order determination unit 130 estimates the amount of memory usage. FIG. 12 is an explanatory diagram showing another example of an amount of memory usage estimated by the IR execution order determination unit 130 based on the IR with the used memory amount information.

The view of the amount of memory usage shown in FIG. 12 is the same as that of the amount of memory usage shown in FIG. 7. The “OpB1” to “OpB3” shown in FIG. 12 represent the Processes 1 to 3 of the computations of Program B shown in FIG. 10, respectively.

Next, the IR execution order determination unit 130 adds each process (Operation) of Program B to each process (Operation) waiting to be executed of Program A so that the amount of memory usage does not exceed the threshold value.

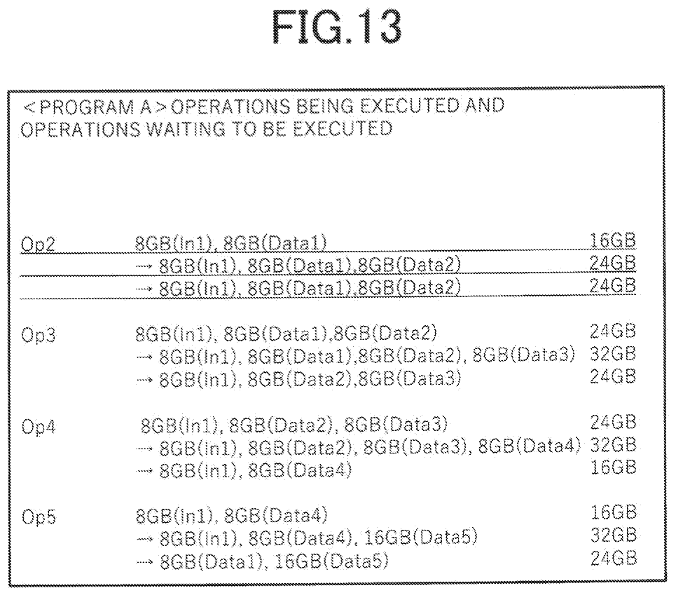

FIG. 13 is an explanatory diagram showing another example of an amount of memory usage estimated by the IR execution order determination unit 130 based on the IR with the used memory amount information. FIG. 13 corresponds to Program A shown in the upper of FIG. 10. In other words, the underlined “Op2” shown in FIG. 13 is the process being executed. “Op3” to “Op5” shown in FIG. 13 are processes waiting to be executed.

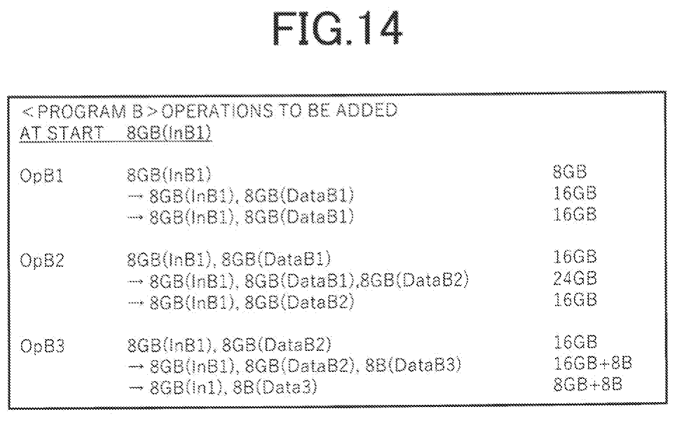

FIG. 14 is an explanatory diagram showing another example of an amount of memory usage estimated by the IR execution order determination unit 130 based on the IR with the used memory amount information. FIG. 14 corresponds to Program B shown in the upper of FIG. 10. In other words, the underlined “at start” shown in FIG. 14 is the current stage of Program B. The “OpB1” to “OpB3” shown in FIG. 14 are the processes to be added.

The IR execution order determination unit 130 adds each process of Program B to each process waiting for execution of Program A. FIG. 15 is an explanatory diagram showing another example of an amount of memory usage estimated by the IR execution order determination unit 130 based on the IR with the used memory amount information. The view of the amount of memory usage shown in FIG. 15 is the same as that of the amount of memory usage shown in FIG. 13.

Unlike FIG. 13, the space between “Op4” and “Op5” is left empty in FIG. 15. The IR execution order determination unit 130 adds each process of Program B so that each process of Program B is executed at vacant space shown in FIG. 15.

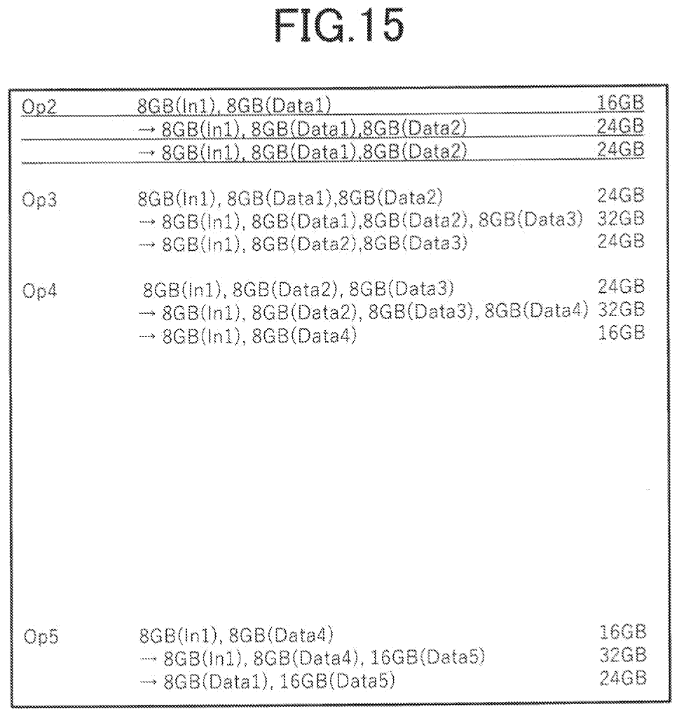

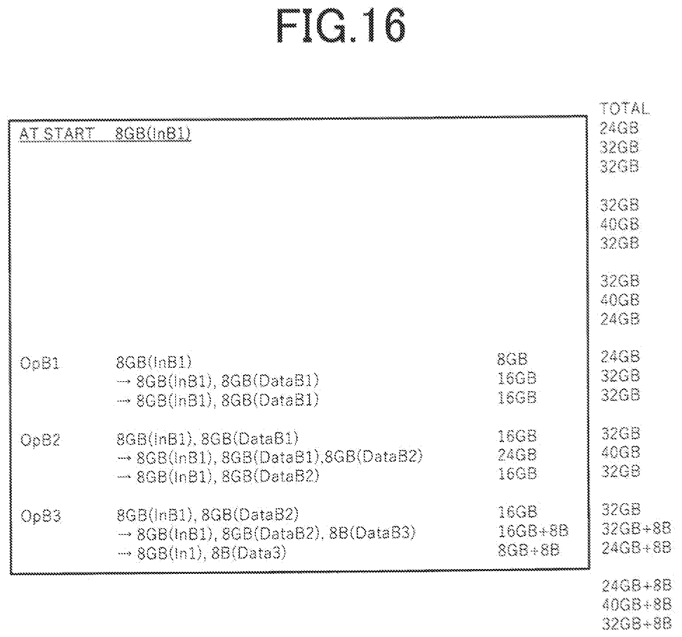

FIG. 16 is an explanatory diagram showing another example of an amount of memory usage estimated by the IR execution order determination unit 130 based on the IR with the used memory amount information. The view of the amount of memory usage shown in FIG. 16 is the same as that of the amount of memory usage shown in FIG. 14.

As shown in FIG. 16, the IR execution order determination unit 130 adjusts the execution timing of each process so that “OpB1” through “OpB3” are executed after “Op4” of Program A is completed. In the example shown in FIG. 16, the IR execution order determination unit 130 adds each process of Program B to each process waiting for execution of Program A to minimize the amount of memory usage.

The “Total” shown on the right side of FIG. 16 is the sum of the amount of memory usage of Program A shown in FIG. 15 and the amount of memory usage of Program B shown in FIG. 16. The maximum value of the total is 40 GB, such as during the execution of “OpB2”. In other words, the sum of the amount of memory usage of Program A and the amount of memory usage of Program B is less than the threshold value that is 40 GB, so even if Program A and Program B are executed simultaneously, the GPU will not run out of memory.

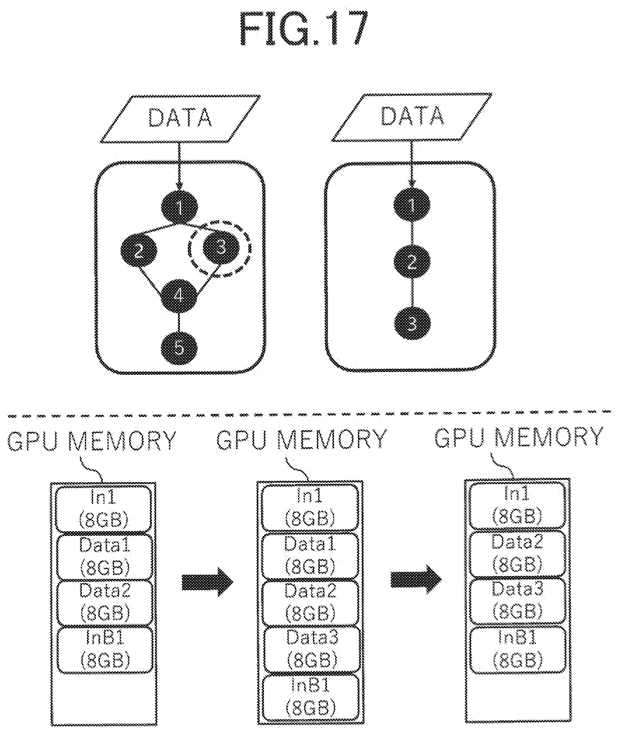

FIG. 17 is an explanatory diagram showing another example of GPU memory when the IR execution unit 140 executes an IR. The upper of FIG. 17 shows that Process 3 is being computed in the execution of Program A. The upper of FIG. 17 shows that each process of Program B is waiting to be executed.

Therefore, as shown in the lower of FIG. 17, output data “Data3” is newly stored in the center GPU memory. The output data “Data1”, which is no longer needed after an IR is executed, is deleted from the right GPU memory. As shown in the lower of FIG. 17, the amount of memory usage of output data “Data3” is 8 GB, as estimated in FIG. 15.

Therefore, the IR execution unit 140 can execute two programs simultaneously without running out of GPU memory by executing IRs in the order determined by the IR execution order determination unit 130.

As described above, the IR generation unit 110 and the IR generation unit 120 of this example embodiment convert multiple programs to be simultaneously executed by the accelerator (GPU) into intermediate representations (Operation information) indicating the computation operations to be executed by the programs and memory information (Data information) indicating the amount of memory required by the data used in the computation operations, respectively.

The IR execution order determination unit 130 of this example embodiment also determines the execution order of the multiple intermediate representations so that the amount of memory (GPU memory) usage used by the accelerator when the accelerator executes multiple programs simultaneously is below a threshold value of the memory based on the converted multiple intermediate representations and multiple memory information.

The program control device 100 of this example embodiment also includes an accelerator (the IR execution unit 140) that simultaneously executes multiple programs by executing multiple intermediate representations according to a determined execution order.

The memory information of this example embodiment also includes the range of computation operations in which the data is used (contents indicated by the “Keep Flag”).

### Description of Operation

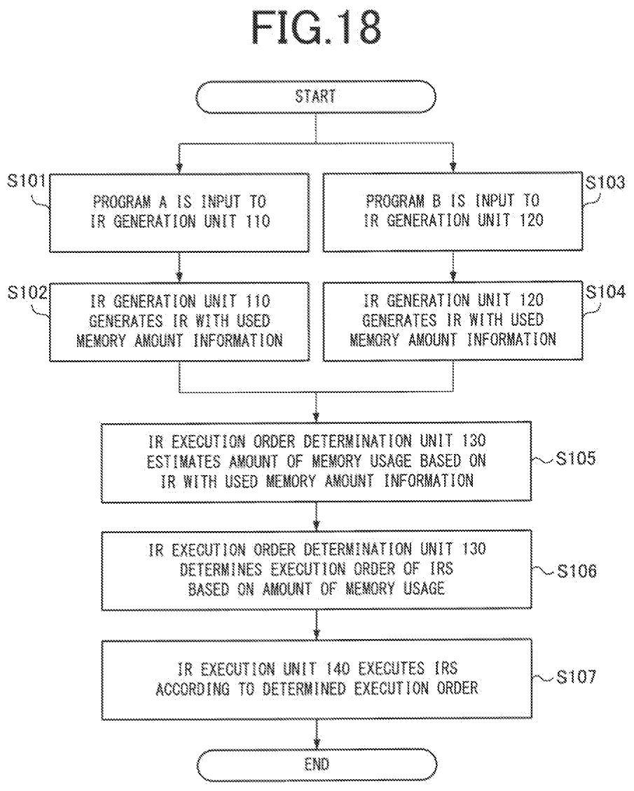

The operation for executing an IR of the program control device 100 of this example embodiment will be described below with reference to FIG. 18. FIG. 18 is a flowchart showing an operation of the IR execution process by the program control device 100 of the present example embodiment.

First, Program A is input to the IR generation unit 110 of the program control device 100 (step S101).

Next, the IR generation unit 110 generates IR with the used memory amount information from Program A (step S102). The IR generation unit 110 inputs the generated IR with the used memory amount information to the IR execution order determination unit 130.

In addition, Program B is input to the IR generation unit 120 of the program control device 100 (step S103).

Next, the IR generation unit 120 generates IR with the used memory amount information from Program B (step S104). The IR generation unit 120 inputs the generated IR with the used memory amount information to the IR execution order determination unit 130.

Next, the IR execution order determination unit 130 estimates the amount of memory usage when Program A and Program B are executed, respectively, based on the input IR with the used memory amount information (step S105).

Next, the IR execution order determination unit 130 determines the execution order of the IRs of Program A and Program B based on the estimated respective amount of memory usage (step S106). The IR execution order determination unit 130 inputs the IRs of Program A and Program B, together with the determined execution order, to the IR execution unit 140.

Next, the IR execution unit 140 executes the input IRs according to the determined execution order (step S107). After executing the IRs, the program control device 100 terminates the IR execution process.

### Description of Effects

In determining the IR execution order, the IR execution order determination unit 130 of this example embodiment adds the processing of other programs so that the amount of memory usage does not exceed the threshold value of GPU memory for each process waiting for program execution. Therefore, the IR execution unit 140 (GPU) of this example embodiment can execute multiple programs simultaneously at high speed without running out of GPU memory.

### Modified Example

This modified example is an example in which the program control device 100 saves the minimum necessary data to CPU memory when the amount of memory usage exceeds the size of GPU memory as a result of the amount of memory usage estimation. Specifically, consider the case where the IR execution order determination unit 130 cannot add each process of Program B without the amount of memory usage exceeding the threshold value because the amount of memory usage of Program B is too large for each process waiting to be executed in Program A.

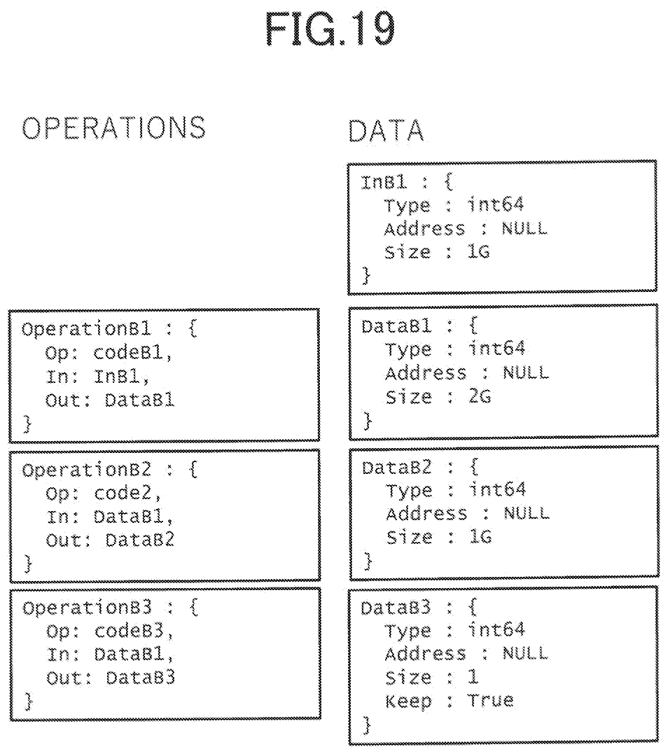

FIG. 19 is an explanatory diagram showing another example of the IR with the used memory amount information that is generated by the IR generation unit 120. In “DataB1” shown in FIG. 11, “Size: 1 G” is specified, but in “DataB1” shown in FIG. 19, “Size: 2 G” is specified.

In other words, the Data information “DataB1” indicates that “DataB1” is a 64-bit signed integer with a size of 2 G. Therefore, the IR execution order determination unit 130 estimates that the amount of memory usage of the output data “DataB1” is 8 Bytes×2 G=16 GB.

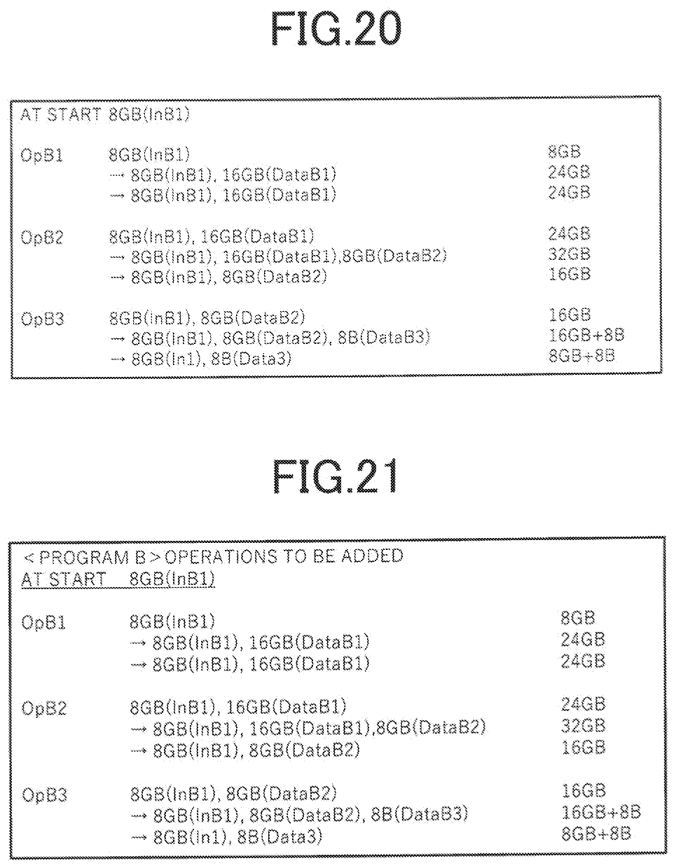

FIG. 20 is an explanatory diagram showing another example of an amount of memory usage estimated by the IR execution order determination unit 130 based on the IR with the used memory amount information. In FIG. 20, the amount of memory usage of a part of “OpB1” and “OpB2” that use “DataB1” is 8 GB larger than that of “OpB1” and “OpB2” shown in FIG. 12.

FIG. 21 is an explanatory diagram showing another example of an amount of memory usage estimated by the IR execution order determination unit 130 based on the IR with the used memory amount information. FIG. 21 corresponds to Program B shown in the upper of FIG. 10.

The view of the amount of memory usage shown in FIG. 21 is the same as that of the amount of memory usage shown in FIG. 14. In this modified example, the amount of memory usage corresponding to Program A shown in the upper of FIG. 10 is the amount of memory usage shown in FIG. 13.

Referring to FIG. 13 and FIG. 21, the IR execution order determination unit 130 cannot add each process of Program B to each process waiting for execution of Program A so that the amount of memory usage does not exceed the threshold value. Specifically, no matter where “OpB2” of Program B is added to “Op2” to “Op5” of Program A, the amount of memory usage exceeds the threshold value that is 40 GB.

Therefore, the IR execution order determination unit 130 first determines the location with the smallest amount of memory usage, specifically adding “OpB2” between “Op4” and “Op5”. To add “OpB2,” the IR execution order determination unit 130 saves the data used in Program A. The location where the data is saved is, for example, the CPU memory.

The amount that must be saved is 16+32−40=8 GB. Therefore, the IR execution order determination unit 130 decides to save “Data4” (8 GB) used in “Op4” before “OpB2” is executed.

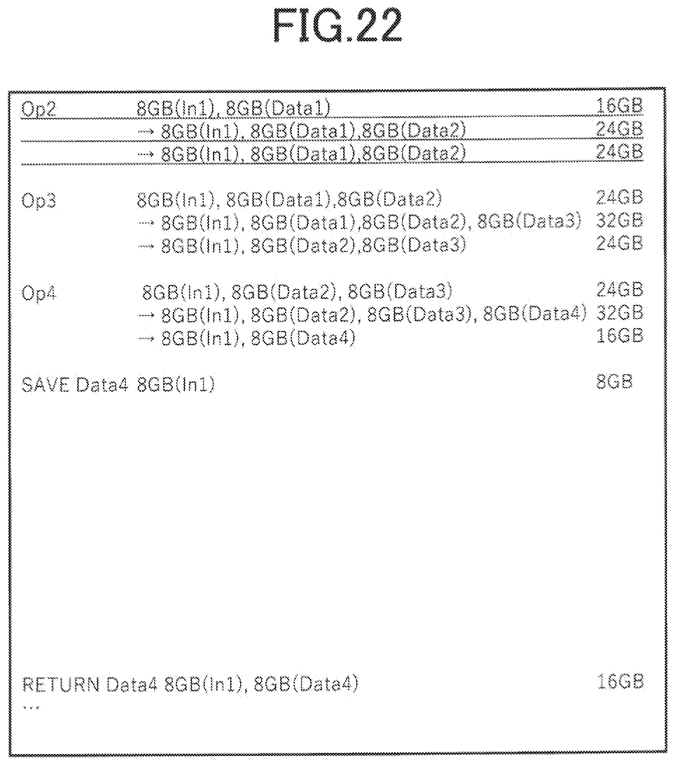

FIG. 22 is an explanatory diagram showing another example of an amount of memory usage estimated by the IR execution order determination unit 130 based on the IR with the used memory amount information. The view of the amount of memory usage shown in FIG. 22 is the same as that of the amount of memory usage shown in FIG. 15.

Unlike FIG. 15, in FIG. 22, there is a space between “Op4” and “Op5” and the process to save “Data4” after the end of “Op4” is specified. Moreover, the process to return “Data4” before the start of “Op5” is specified. The IR execution order determination unit 130 adds each process of Program B so that each process of Program B is executed at vacant space shown in FIG. 22.

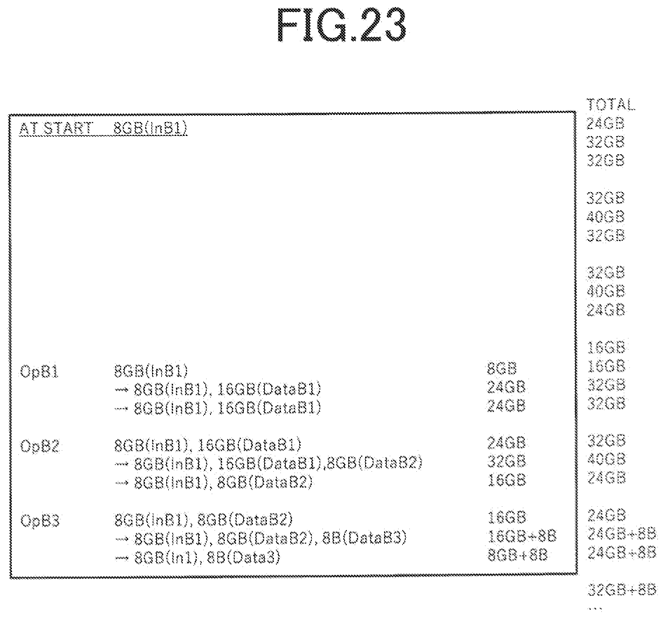

FIG. 23 is an explanatory diagram showing another example of an amount of memory usage estimated by the IR execution order determination unit 130 based on the IR with the used memory amount information. The view of the amount of memory usage shown in FIG. 23 is the same as that of the amount of memory usage shown in FIG. 16.

The maximum value of the total shown in FIG. 23 is 40 GB, such as during the execution of “OpB2”. In other words, the sum of the amount of memory usage of Program A shown in FIG. 22 and the amount of memory usage of Program B shown in FIG. 23 is less than the threshold value that is 40 GB, so even if Program A and Program B are executed simultaneously, the GPU memory will not run out.

As described above, the IR execution order determination unit 130 in this modified example includes in the multiple intermediate representations the process of saving data used in computation operations to memory used by computing devices other than accelerators.

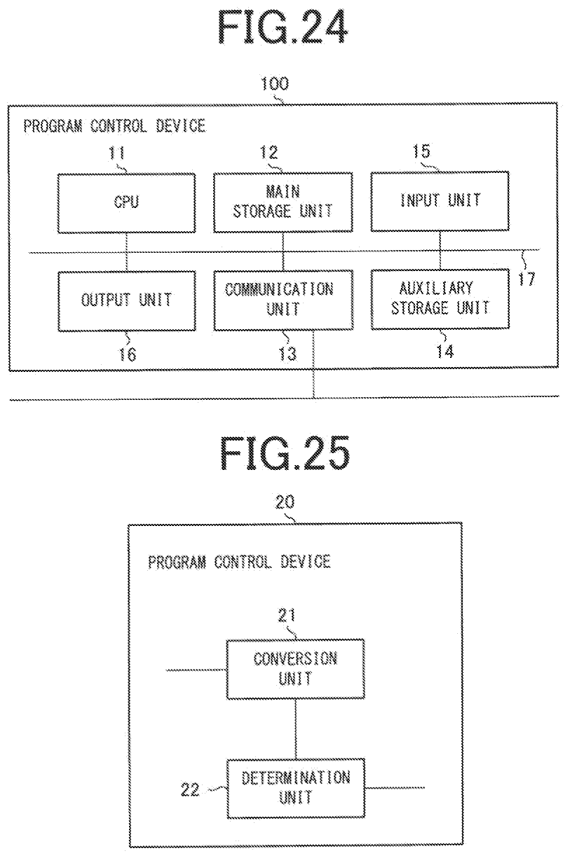

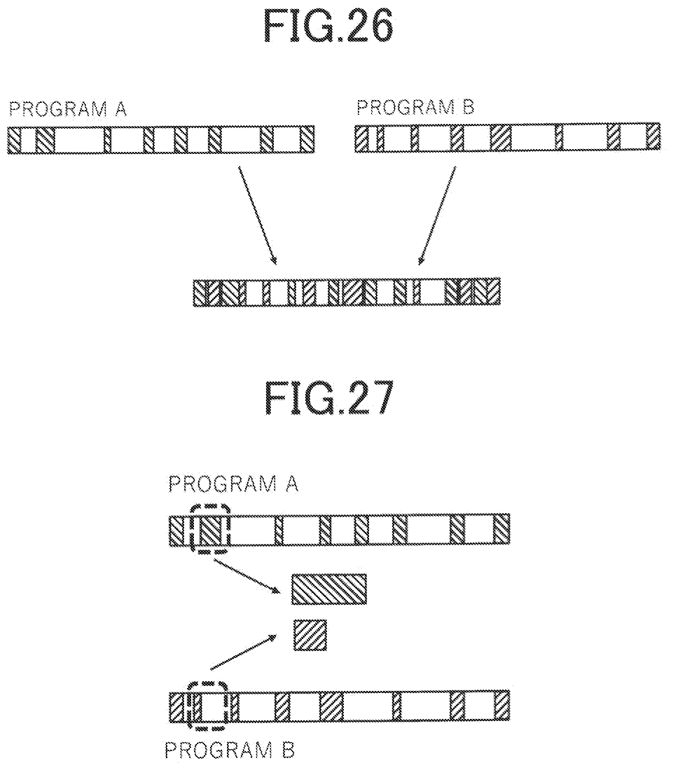

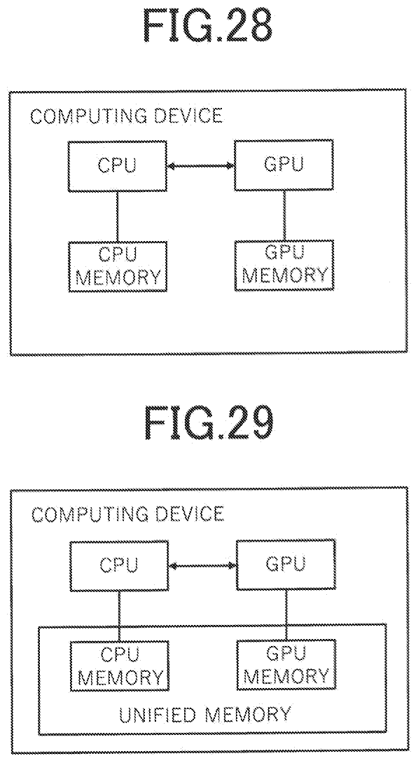

A specific example of a hardware configuration of the program control device 100 according to this example embodiment will be described below. FIG. 24 is an explanatory diagram showing an example of a hardware configuration of the program control device 100 according to the present invention.

The program control device 100 shown in FIG. 24 includes a CPU 11, a main storage unit 12, a communication unit 13, and an auxiliary storage unit 14. The program control device 100 also includes an input unit 15 for the user to operate and an output unit 16 for presenting a processing result or a progress of the processing contents to the user.

The program control device 100 is realized by software, with the CPU 11 shown in FIG. 24 executing a program that provides a function that each component has.

Specifically, each function is realized by software as the CPU 11 loads the program stored in the auxiliary storage unit 14 into the main storage unit 12 and executes it to control the operation of the program control device 100.

The program control device 100 shown in FIG. 24 may include a DSP (Digital Signal Processor) instead of the CPU 11. Alternatively, the program control device 100 shown in FIG. 24 may include both the CPU 11 and the DSP.

The main storage unit 12 is used as a work area for data and a temporary save area for data. The main storage unit 12 is, for example, RAM (Random Access Memory).

The communication unit 13 has a function of inputting and outputting data to and from peripheral devices through a wired network or a wireless network (information communication network).

The auxiliary storage unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The input unit 15 is, for example, an input device such as a keyboard, a mouse, or a touch panel.

The output unit 16 has a function to output data. The output unit 16 is, for example, a display device such as a liquid crystal display device, a touch panel, or a printing device such as a printer.

As shown in FIG. 24, in the program control device 100, each component is connected to the system bus 17.

The auxiliary storage unit 14 stores programs for realizing the IR generation unit 110, the IR generation unit 120, and the IR execution order determination unit 130 in the program control device 100. As mentioned above, the IR execution unit 140 is realized by, for example, a GPU (not shown).

The program control device 100 may be implemented with a circuit that contains hardware components inside such as an LSI (Large Scale Integration) that realize the functions shown in FIG. 1, for example.

The program control device 100 may be realized by hardware that does not include computer functions using elements such as a CPU. For example, some or all of the components may be realized by a general-purpose circuit (circuitry) or a dedicated circuit, a processor, or a combination of these. They may be configured by a single chip (for example, the LSI described above) or by multiple chips connected via a bus. Some or all of the components may be realized by a combination of the above-mentioned circuit, etc. and a program.

Some or all of each component of the program control device 100 may be configured by one or more information processing devices which include a computation unit and a storage unit.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

Next, an overview of the present invention will be explained. FIG. 25 is a block diagram showing an overview of a program control device according to the present invention. The program control device 20 according to the present invention includes a conversion unit 21 (for example, the IR generation unit 110 and the IR generation unit 120) which converts multiple programs to be simultaneously executed by an accelerator into intermediate representations indicating computation operations to be executed by programs and memory information indicating an amount of memory required by data used in the computation operations, respectively, and a determination unit 22 (for example, the IR execution order determination unit 130) which determines an execution order of multiple intermediate representations so that an amount of memory usage used by the accelerator when the accelerator executes the multiple programs simultaneously is below a threshold value of the memory based on the converted multiple intermediate representations and multiple memory information.

The program control device 20 may also include the accelerator (for example, the IR execution unit 140) which simultaneously executes the multiple programs by executing the multiple intermediate representations according to a determined execution order.

When a program control device with such a configuration is used, the accelerator can execute multiple programs simultaneously at high speed without running out of memory in the accelerator.

The determination unit 22 may also include in the multiple intermediate representations a process of saving data used in the computation operations to memory used by a computing device (for example, CPU) other than the accelerator.

When a program control device with such a configuration is used, the accelerator can execute multiple programs simultaneously at high speed without running out of memory in the accelerator.

The accelerator may also be a computing element (computing device) other than a GPU. The memory information may also include a range of the computation operations in which data is used.

When Unified Memory is used, the following problems may occur. If a Page Fault, which occurs due to competition for virtual memory region (page) is detected when accessing the address space of Unified Memory, a data copy process is executed between the CPU and GPU. The above mechanism automatically moves the data to CPU memory or GPU memory.

However, if Page Faults occur frequently, they can become a large overhead and slow down the processing speed of the computing device. In other words, even if the shortage of GPU memory is solved by using Unified Memory when multiple programs are executed by the GPU simultaneously, Page Faults occur frequently, resulting in a problem of a slowdown of the processing speed of the computing device.

Techniques that can solve the problem of a slowdown of the processing speed due to Page Fault caused by competition for GPU memory pages when there is not enough GPU memory are not described in Japanese Patent Application Laid-Open No. 2022-022642, Japanese Patent Application Laid-Open No. 2014-229173, and Japanese Patent Application Laid-Open No. 2008-165746.

According to this invention, the accelerator can simultaneously execute multiple programs at high speed without running out of memory in the accelerator.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

What is claimed is:

1. A program control device comprising:
a memory configured to store instructions; and
a processor configured to execute the instructions to:
convert multiple programs to be simultaneously executed by an accelerator into intermediate representations indicating computation operations to be executed by programs and memory information indicating an amount of memory required by data used in the computation operations, respectively; and
determine an execution order of multiple intermediate representations so that an amount of memory usage used by the accelerator when the accelerator executes the multiple programs simultaneously is below a threshold value of the memory based on the converted multiple intermediate representations and multiple memory information.

2. The program control device according to claim 1, further comprising:
the accelerator which simultaneously executes the multiple programs by executing the multiple intermediate representations according to a determined execution order.

3. The program control device according to claim 1, wherein the processor is further configured to execute the instructions to:
include in the multiple intermediate representations a process of saving data used in the computation operations to memory used by a computing device other than the accelerator.

4. The program control device according to claim 1, wherein
the memory information includes a range of the computation operations in which data is used.

5. A program control method comprising:
converting multiple programs to be simultaneously executed by an accelerator into intermediate representations indicating computation operations to be executed by programs and memory information indicating an amount of memory required by data used in the computation operations, respectively; and
determining an execution order of multiple intermediate representations so that an amount of memory usage used by the accelerator when the accelerator executes the multiple programs simultaneously is below a threshold value of the memory based on the converted multiple intermediate representations and multiple memory information.

6. The program control method according to claim 5, wherein
the accelerator simultaneously executes the multiple programs by executing the multiple intermediate representations according to a determined execution order.

7. The program control method according to claim 5, further comprising:
including in the multiple intermediate representations a process of saving data used in the computation operations to memory used by a computing device other than the accelerator.

8. A computer-readable recording medium recording a program control program causing an accelerator to execute:
converting multiple programs to be simultaneously executed by the accelerator into intermediate representations indicating computation operations to be executed by programs and memory information indicating an amount of memory required by data used in the computation operations, respectively; and
determining an execution order of multiple intermediate representations so that an amount of memory usage used by the accelerator when the accelerator executes the multiple programs simultaneously is below a threshold value of the memory based on the converted multiple intermediate representations and multiple memory information.

9. The recording medium recording the program control program according to claim 8, causing the accelerator to execute:
simultaneously executing the multiple programs by executing the multiple intermediate representations according to a determined execution order.

10. The recording medium recording the program control program according to claim 8, causing the accelerator to execute:
including in the multiple intermediate representations a process of saving data used in the computation operations to memory used by a computing device other than the accelerator.
